(19) United States
(12) Patent Application Publication
(10) Pub. No.: US 2025/0375915 A1
(43) Pub. Date: Dec. 11, 2025

(54) SYSTEM FOR EMPLOYING SENSOR FUSION WITH RESPECT TO PROTECTING AN OPERATOR OF A POWER TOOL

(71) Applicant: HUSQVARNA AB, Huskvarna (SE)

(72) Inventors: Guoliang WANG, Solna (SE); Niklas SARIUS, Jonkoping (SE)

(21) Appl. No.: 19/127,962

(22) PCT Filed: Nov. 6, 2023
(86) PCT No.: PCT/EP2023/080774

§ 371 Date: May 7, 2025

(30) Foreign Application Priority Data
Nov. 7, 2022 (SE) 2251297-4

(51) Int. Cl. B27G 19/00; B27B 17/08

(52) U.S. Cl. CPC B27G 19/008; B27B 17/083

(57) ABSTRACT

A system for protecting an operator (110) of a power tool (100) may include a first sensor network (240), a second sensor network (250), a third sensor network (252), and a controller (140) configured to detect a trigger event based on measurements made by the first, second and third sensor networks (240, 250 and 252) and initiate a protective action with respect to the power tool (100) responsive to detecting the trigger event. The controller (140) may be further configured to monitor performance data associated with each of the first, second and third sensor networks (240, 250 and 252) to perform sensor fusion based on the performance data.

### TECHNICAL FIELD

Example embodiments generally relate to power equipment and, more particularly, relate to a system configured to intelligently protect the user of a chainsaw or other power equipment such as power cutters with blade or chain by employing sensor fusion involving different types of sensors.

### BACKGROUND

Property maintenance tasks are commonly performed using various tools and/or machines that are configured for the performance of corresponding specific tasks. Some of those tools, like chainsaws, are designed to be effective at cutting trees in situations that could be relatively brief, or could take a long time including, in some cases, a full day of work. When operating a chainsaw for a long period of time, fatigue can play a role in safe operation of the device. However, regardless of how long the operator uses the device, it is important that the operator remain vigilant to implementing safe operating procedures in order to avoid injury to himself/herself and to others.

To help improve safety, operators are encouraged to wear protective clothing and other personal protective equipment (PPE). However, some operators may find the PPE to be uncomfortable and, depending on the weather, may work with very thin clothes on their upper bodies. Accordingly, outdoor power equipment manufacturers have tried to develop “intelligent” protection solutions that do not rely on PPE in order to protect users of chainsaws and other outdoor power equipment. In doing so, numerous different types of sensors have been employed, and it can fairly be said that each type of sensor has its own advantages and disadvantages.

Thus, in selecting a protection solution involving any one of the different types of sensors, the disadvantages of that type of sensor are necessarily accepted for the entire solution. Example embodiments aim to correct this deficiency by providing sensor fusion that can integrate the advantages and mitigate disadvantages to improve performance.

### BRIEF SUMMARY OF SOME EXAMPLES

Some example embodiments may provide a system for protecting an operator of a power tool. The system may include a first sensor network, a second sensor network, a third sensor network, and a controller configured to detect a trigger event based on measurements made by the first, second and third sensor networks and initiate a protective action with respect to the power tool responsive to detecting the trigger event. The controller may be further configured to monitor performance data associated with each of the first, second and third sensor networks to perform sensor fusion based on the performance data.

In one example embodiment, a controller for protecting an operator of a power tool may be provided. The controller may include processing circuitry that is operably coupled to a first sensor network, a second sensor network, and a third sensor network. The controller may be configured to detect a trigger event based on measurements made by the first, second and third sensor networks and initiate a protective action with respect to the power tool responsive to detecting the trigger event. The controller may be further configured to monitor performance data associated with each of the first, second and third sensor networks to perform sensor fusion based on the performance data.

Some example embodiments may improve the user experience, safety, and/or productivity during use of outdoor powered equipment.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a concept diagram of a system in which multiple sensor networks may operate in accordance with an example embodiment;

FIG. 2 illustrates a block diagram of a system for providing operator protection in accordance with an example embodiment;

FIG. 3 illustrates a schematic diagram showing how known distances in prescribed poses may be used for calibration of sensors in accordance with an example embodiment;

FIG. 4 illustrates a block diagram of a method of employing sensor fusion in accordance with an example embodiment; and

FIG. 5 is a block diagram of a set of trigger events that may be employed with two different sets of sensors in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection or interaction of components that are operably coupled to each other.

Some example embodiments may provide for an intelligent protection system that is configured to monitor a position of the guide bar or blade (or other working assembly) of the chainsaw (or other power equipment) relative to body parts of the user. The system is configured to detect when the user's body parts come too close to the guide bar or blade, or otherwise detect when situations arise for which stopping of the chain is desirable. Both the user and the PPE can therefore be protected during operation of various types of cutting equipment.

With respect to the goal discussed above, no single solution, or type of sensor is to be relied upon. Instead, sensor fusion that employs multiple different types of sensors is to be employed. In this regard, by using multiple types of sensors, and further by employing sensor fusion as described herein, input from one type of sensors may be used to improve the accuracy of another type of sensor. Thus, self-calibrating sensor networks may be defined. However, beyond merely improving accuracy, the sensor fusion of example embodiments may also be employed to detect when a specific set of sensors (of a given type) are not performing either at all, or to required performance levels. Accordingly, example embodiments may also engage in continuous self-assessment to determine which sets of sensors (or sensor types) are to be prioritized in a given situation, or conversely, not to be relied upon in a given situation due to compromised accuracy. The compromise in accuracy may be momentary or apparently permanent, and the user may be informed so that maintenance or repair on specific sensor types or sets of sensors (or even individual sensors) may be performed. Example embodiments may also, when one set of sensors is identified as not performing to expectations, define fail-over strategies to employ other sets of sensors or combinations thereof. Thus, example embodiments may define sensor redundancy and self-healing that enables the sensors of different types to be employed for either improving the performance of compromised sets of sensors, or to replace them entirely within the protection strategy being employed.

In some embodiments, one of the types of sensors that may be employed may be employed as a first set of sensors (of a given type) may include inertial measurement unit (IMU) based tracking sensors on the device (e.g., near the guide bar or blade) and on the body parts that are to be protected. IMU based sensors may include three axis accelerometers, gyroscopes and/or magnetometers in order to track movement in three dimensions. This type of tracking is commonly employed in ergonomic and sports research, and is used for special effects in movies and computer games, in order to track body motion. Putting sensors also on or near the guide bar or blade may enable the body motion to be tracked relative to the guide bar or blade, so that protective actions could be prescribed when such tracking indicated a potential intersection between the guide bar or blade and a part of the body. Moreover, volumes could be modeled around each of the body parts and the guide bar or blade in order to define protected volumes (e.g., defined by the body part (or other object) and a predetermined distance around the body part/object) that, when breached, cause protective actions to be implemented.

However, there are known accuracy issues associated with IMU based tracking sensors. In this regard, pure-IMU based displacement calculation solutions (i.e., dead reckoning) introduce calculation errors due to inaccuracy of the sensors, noise, and limitations associated with the calculation platform. Accordingly, some example embodiments may define a system that enables the calibration of IMU-based tracking sensors using a second (or other) set of sensors of a different type so that calibrated motion tracking may be enabled. Additionally or alternatively, the IMU-based tracking sensors may be combined with other sensors (e.g., distance measurement sensors) to define a system that employs sensor fusion for improved accuracy with respect to tracking movement or distances of body parts from a working assembly to define a trigger event and protective function initiation.

By improving accuracy, and by providing redundancy, a future possibility of defining a system that is both accurate and reliable enough to be operated with or without PPE can potentially be realized. As such, example embodiments may include the provision of sensor fusion with combinations of different types of sensors and tracking mechanisms. Example embodiments may also include the provision of tracking algorithms and/or methods that employ sensors for measuring distances accurately using adaptive signal strength measurements.

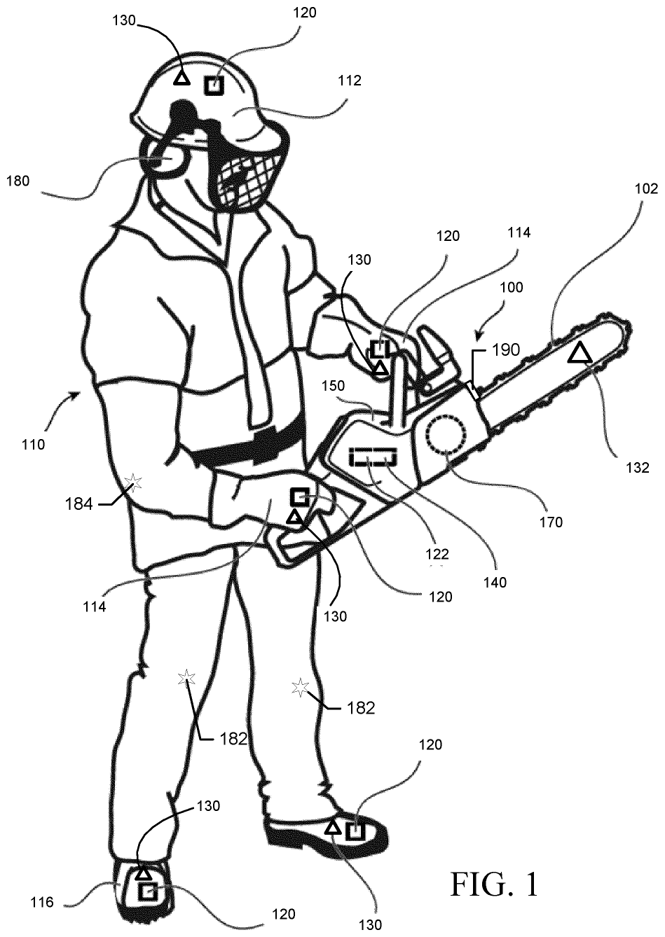

FIG. 1 illustrates an intelligent protection system of an example embodiment being applied where the outdoor power equipment is a chainsaw 100 having an endless chain 102 that rotates about a guide bar to perform cutting operations. As shown in FIG. 1, an operator 110 wears multiple sets of sensors (some of which may be wearable sensors). In this regard, the operator 110 is wearing a helmet 112, gloves 114, and boots 116 as examples of PPE. The sensors may be integrated into the PPE, or may be attached thereto. Of course, the sensors could alternatively be integrated into or attached to other clothing or gear, and at other locations as well such as, for example, in a shirt, jacket or trousers. Thus, the specific examples shown in FIG. 1 should be appreciated as being non-limiting in relation to the numbers of sensors, locations of the sensors, and methods of attaching the sensors to the operator 110 and/or the gear of the operator 110.

In this example, the multiple sets of sensors include a first set of sensors that are IMU-based sensors 120. The IMU-based sensors 120 of FIG. 1 are disposed on the helmet 112, gloves 114 and boots 116 that the operator 110 is wearing, but could be at other locations as well, as noted above. Thus, for example, additional IMU-based sensors 120 could be provided at the knees, elbows, chest or other desirable locations on the operator 110. The IMU-based sensors 120 may operate in cooperation with a tool position sensor 122, which may be disposed at a portion of the tool (e.g., chainsaw 100). Of note, the tool position sensor 122 may itself be an IMU-based sensor and/or may include a set of such sensors. However, in other cases, the tool position sensor 122 may be an example of a sensor of one of the other types of sensors described below in connection with third, fourth or fifth sets of sensors. In this specific example, the IMU-based sensors 120 and the tool position sensor 122 may each be configured to perform motion tracking in three dimensions in order to enable relative positions between body parts at which the IMU-based sensors 120 are located and the tool to be tracked. The motion tracking may be performed in connection with the application of motion tracking algorithms on linear acceleration and angular velocity data in three dimensions. If the motion indicates that a body part of the operator 110 gets too close to the working assembly (e.g., chain 102) of the chainsaw 100, then the trigger event may be detected and a protective action may be initiated.

The multiple sets of sensors also include a second set of sensors that are distance sensors 130. Although the distance sensors 130 of this example are shown to be in the same locations on the operator 110 that the IMU-based sensors 120 have been placed, such correspondence is not necessary. As such, more or fewer distance sensors 130 could be provided than IMU-based sensors 120, and the distance sensors 130 could be provided at the same or different locations on the operator 110. The distance sensors 130 may be configured to operate in cooperation with a tool distance sensor 132 that may be disposed at a portion of the tool (e.g., chainsaw 100). In this example, the tool distance sensor 132 may be disposed at a guide bar of the chainsaw 100 so that distance measurements made between the tool distance sensor 132 and one or more of the distance sensors 130 are indicative of a distance between the guide bar and the body part on which the corresponding one of the distance sensors 130 is being worn. Of note, the tool distance sensor 132 may be a single sensor and/or may include a set of such sensors.

In an example embodiment, the distance sensors 130 may employ radar, lidar, ultrasound, ultra wideband (UWB), or other such sensors that enable distance to be directly determined. Thus, for example, some of the distance sensors 130 may employ a carrier wave of some type and compute round trip flight times from a sensor (or transmitter proximate to such sensor) to an object off of which the carrier wave reflects, and then back to the sensor. In some other cases, a one way flight time could be employed to determine the distance as well. Specific operations of some types of the distance sensors 130 will be described in greater detail below. However, generally speaking, the distance sensors 130 may be referred to as time-of-flight sensors.

In this regard, the distance measurement information may be calculated from the time of flight of a transmitted signal if the velocity of the carrier wave is known. For electromagnetic signals (e.g., laser, infrared, radio-frequency), the velocity is known to be the speed of light. For sound or audible signals, the velocity is known to be the speed of sound, and the distance sensors 130 may be transmitters so that the tool distance sensor 132 only measures a one way time of flight. Sensors may therefore be disposed at known locations on body parts of the operator 110, so that if such body parts get within a given distance of the working assembly of the chainsaw 100, the trigger event is detected and protective action is initiated.

The multiple sets of sensors may also include a third set of sensors that are magnetic sensors 182. The magnetic sensors 182 may utilize magnetic fields generated by permanent magnets or electromagnets disposed on the chainsaw 100 and/or on the operator 110 (e.g., on PPE worn by the operator 110) and interactions between the magnetic sensors 182 and, in some cases perhaps also the earth's magnetic field, to determine the proximity of the chainsaw 100 (or working assembly thereof) to the operator 110 or various other objects. In some cases, the magnetic sensors 182 may be able to detect magnetic field modifications (e.g., of the earth or of other magnets) that are made by the metal in the chainsaw 100 or the chain 102 or blade of the chainsaw 100.

As an example, one or more instances of the magnetic sensors 182 may be provided on body parts of the operator 110, and the magnetic sensors 182 may detect modifications in the earth's magnetic field made by the chainsaw 100 (or portions thereof) to determine proximity of the chainsaw 100 (or its working assembly) to the body part(s). Alternatively, the working assembly or another part of the chainsaw 100 may emit magnetism (e.g., from a permanent or electromagnet) that is detected by the magnetic sensors 182. In either case, the detection of changes in magnetic field may determine proximity of the chainsaw 100 (or its working assembly) to the body part(s) associated with the magnetic sensors 182 and the trigger event may be detected when the proximity is within a threshold distance.

In this example, the magnetic sensors 182 are shown on the operator 110, but it should be appreciated that the tool position sensor 122 and/or the tool distance sensor 132 shown could indicate a location for (or represent) another instance of magnetic sensor at a corresponding portion of the chainsaw 100. Moreover, the locations of the magnetic sensors 182 shown are just examples, and sensors at other locations are also possible, and may be preferable in other situations or applications.

The multiple sets of sensors may also include a fourth set of sensors that are electronic tag sensors 184. The electronic tag sensors 184 may include radio frequency identification (RFID) tags, UWB sensors, and/or the like. RFID tags may employ power level measurement techniques to determine distance between tags. Thus, for example, one tag or reader may be on the chainsaw 100 and another tag or reader may be on the operator 110 (or PPE worn by the operator 110) and power levels may be measured to infer distance. In some cases, power levels may be changed and measured to infer distance when certain threshold power levels are reached or, for example, when an increasing power level is reached when reading is first detected, or decreasing to a level where the reading is no longer possible. UWB sensors may employ trilateration with respect to sensing of a transmit pulse by multiple sensors.

In this example, the electronic tag sensors 184 are shown on the operator 110, but it should be appreciated that the tool position sensor 122 and/or the tool distance sensor 132 shown could indicate a location for (or represent) another instance of electronic tag sensor or reader at a corresponding portion of the chainsaw 100. Moreover, the locations of the electronic tag sensors 184 shown are just examples, and sensors at other locations are also possible, and may be preferable in other situations or applications. As above, when a distance is inferred that is too close to the working assembly, the trigger event may be considered to be detected.

The multiple sets of sensors may also include a fifth set of sensors that are optical sensors 190. In this regard, for example, the optical sensors 190 may include one or more cameras and/or infrared sensors. In some embodiments, the optical sensors 190 may project a field of view around the chainsaw 100 (or more particularly around the chain 102 or other working assembly of equipment in general). The field of view may also have within it, a safety zone or other region that can be a predefined distance from the chain 102 or working assembly. When an object that should be protected enters into the field of view it can be tracked to determine when a trigger event occurs (e.g., if the object is entering into (e.g., approaching), within, or leaving the safety zone), and protective actions may be taken responsive to detecting the trigger event. In this example, the optical sensors 190 are shown to define an array that can define the field of view around the chain 102. However, the optical sensors 190 may be employed in other locations in other example embodiments.

The optical sensors 190 may, in some cases, be able to distinguish between objects in the field of view using object recognition or various markers or indicators. For example, certain reflective clothing may be detected, or heat signatures may be detected to appreciate that the object is not an inanimate object that is to be cut. Alternatively or additionally, the optical sensors 190 may be trained to detect hand, arm, leg or body shapes that may be learned and discerned. If detected, the trigger event may be detected and protective action may be initiated. However, if the object in the field of view, and entering the safety zone is not recognized, it may be assumed to be an inanimate object to be cut and no trigger event detection may occur.

As can be appreciated from the descriptions above, the IMU-based sensors 120, and perhaps some others as well, may be sensors configured to track movement in three dimensions. In some cases, the accuracy of the IMU-based sensors 120 may be increased by the employment of magnetic liquid (or M-liquid) in association with one or more of the IMU-based sensors 120. In this regard, for example, the M-liquid may tend to always orient itself to have a surface that is parallel to the ground (e.g., the earth's surface). The orientation of the magnetic fluid may provide certain impacts on IMU readings, and those impacts may be used to infer information about the orientation or position of the IMU-based sensors 120 that can be used to provide correction factors or other accuracy enhancements to IMU-based sensor 120 readings.

Meanwhile, the distance sensors 130 may be configured to measure or track distances in either two dimensions or simply in one dimension (i.e., straight line distance). In either case, distances or proximity measurements may be performed so that the chainsaw 100 (or at least the cutting action thereof) may be disabled based on distance or proximity thresholds that can be defined (e.g., for short distances), or based on combinations of relative motion of body parts and the tool at angular velocities or linear velocities above certain thresholds (e.g., stop delay based distances for larger distances).

The various other sensors (e.g., the magnetic sensors 182, electronic tag sensors 184 and/or optical sensors 190) may measure distances or locations of objects relative to each other in one, two or three dimensions as well. Moreover, as noted above, each of the various types of sensors mentioned above may have respective advantages and disadvantages, and the advantages and disadvantages may be enhanced or mitigated in certain situations. Example embodiments may provide a way to be cognizant of the situations that either may cause or are apparently causing reduced or increased performance in one of the sets of sensors. Example embodiments may then employ sensor fusion to provide self-calibrating, self-assessment, and self-healing with respect to a sensor array that includes any or all of the first, second, third, fourth and fifth sets of sensors mentioned above, each of which may be considered to be a corresponding different type of sensor.

In an example embodiment, a controller 140 may be disposed at the tool (e.g., chainsaw 100) and, in this case, may be provided within a housing 150 of the chainsaw 100. However, in some cases, the controller 140 may be disposed at a device worn by the operator 110, but capable of communicating with the chainsaw 100, or even in an on-site device that receives data from multiple operators and/or chainsaws to manage operations and safety for the multiple operators and/or chainsaws. The controller 140 may be configured to communicate with the tool position sensor 122 and/or the IMU-based sensors 120, the distance sensors 130, the tool distance sensor 132, the magnetic sensors 182, the electronic tag sensors 184 and/or the optical sensors 190 mentioned above, in any of the corresponding operational paradigms of the different types of sensors in order to perform motion tracking, object detection, or other trigger event detection as described herein. In FIG. 1, the controller 140 and tool position sensor 122 are shown to be collocated. However, such collocation is not necessary. Moreover, the tool position sensor 122 could be located at any desirable location on the chainsaw 100. Thus, for example, the controller 140 may have a wired or wireless connection to the tool position sensor 122. If communications between the IMU-based sensors 120 and the controller 140 occur, such communication may be accomplished via wireless communication (e.g., short range wireless communication techniques including Bluetooth, WiFi, Zigbee, and/or the like).

The controller 140 may also be in communication with the tool distance sensor 132 or other sensors mentioned above that may measure distance directly. In this regard, for example, the tool distance sensor 132 may be configured to interface with the distance sensors 130 to make distance measurements. The tool distance sensor 132 may then communicate with the controller 140 to provide the distance measurements either on a continuous, periodic or event-driven basis. At one end of the spectrum, continuous distance measurements may be provided to and evaluated by the controller 140 at routine and frequent intervals. At the other end of the spectrum, the distance measurements may only be provided when the distance measured is below a threshold (e.g., minimum) distance. In any case, the controller 140 may be configured to evaluate the distance measurements relative to initiation of warnings or other protective features that the controller 140 may be configured to control. As an example, a chain brake 170 of the chainsaw 100 could be activated if the distance measured for any one of the distance sensors 130 relative to the tool distance sensor 132 is below the threshold distance. Alternatively or additionally, a warning may be provided (e.g., audibly, visually, or via haptic feedback). If hearing protection 180 is worn by the operator 110, an audible warning could be provided via the hearing protection 180. In some cases, the warning may be provided at a first (and larger distance) threshold being met, and the chain brake 170 could be activated for a second (and smaller distance) threshold being met.

The same or a different protection paradigm could also be initiated based on tracking done using the IMU-based sensors 120 and the tool position sensor 122, or any of the other (e.g., third, fourth or fifth sets of sensors). Thus, for example, the controller 140 may be configured to evaluate inputs received from any combination, or even all of the IMU-based sensors 120, the tool position sensor 122, the distance sensors 130, the tool distance sensor 132, the magnetic sensors 182, the electronic tag sensors 184 and/or the optical sensors 190. The evaluations may be performed simultaneously or in sequence to result in a fusion of the motion tracking and distance measurement sensors (and functions). However, it should also be appreciated that separate controllers (e.g., separate instances of the controller 140) may be employed for each respective one of the sets of sensors in some examples. Moreover, as will be discussed in greater detail below, the controller 140 may be configured to prioritize usage of one or the other of motion tracking and distance measurement in specific contexts. For example, distance measurement related measures may have preference (or take precedence) within a certain range of distances (e.g., short distances), and motion tracking related measures may have preference (or take precedence) within another range of distances (e.g., at larger distances). The controller 140 may also be configured to manage calibration of the motion tracking functions of the IMU-based sensors 120 and the tool position sensor 122.

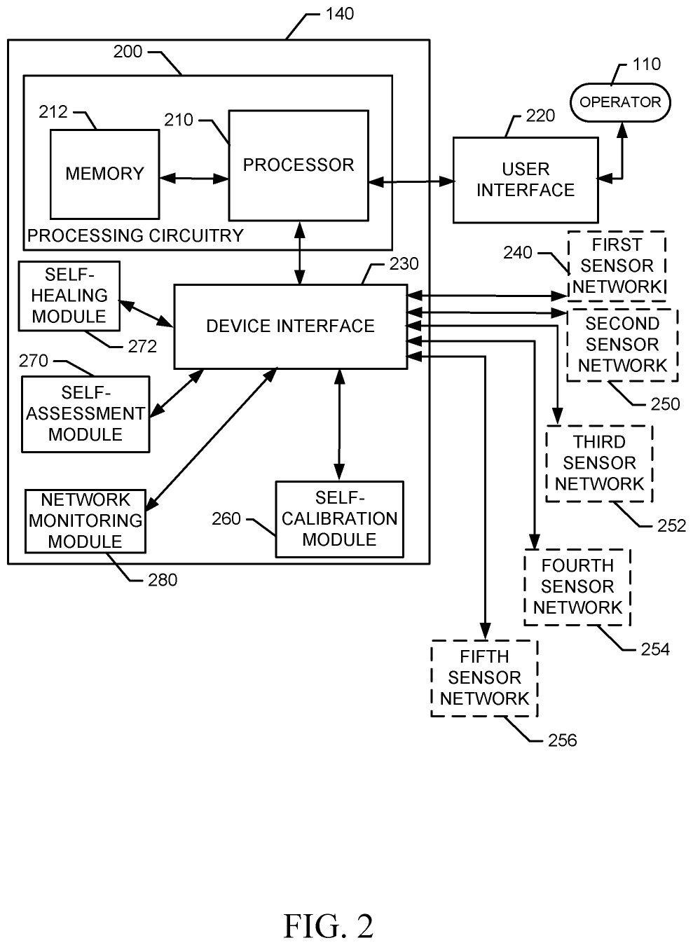

The configuration of the controller 140 for performing sensor fusion and/or calibration in accordance with an example embodiment will now be described in reference to FIG. 2. In this regard, FIG. 2 shows a block diagram of the controller 140 in accordance with an example embodiment. As shown in FIG. 2, the controller 140 may include processing circuitry 200 of an example embodiment as described herein. The processing circuitry 200 may be configured to provide electronic control inputs to one or more functional units of the chainsaw 100 (e.g., the chain brake 170) or the system (e.g., issuing a warning to the hearing protection 180) and to process data received at or generated by the one or more of the motion tracking and distance measurement devices regarding various indications of movement or distance between the tool and the operator 110. Thus, the processing circuitry 200 may be configured to perform data processing, control function execution and/or other processing and management services according to an example embodiment.

In some embodiments, the processing circuitry 200 may be embodied as a chip or chip set. In other words, the processing circuitry 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 200 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 200 may include one or more instances of a processor 210 and memory 212 that may be in communication with or otherwise control other components or modules that interface with the processing circuitry 200. As such, the processing circuitry 200 may be embodied as a circuit chip (e.g., an integrated circuit chip) configured (e.g., with hardware, software or a combination of hardware and software) to perform operations described herein. In some embodiments, the processing circuitry 200 may be embodied as a portion of an onboard computer housed in the housing 150 of the chainsaw 100 to control operation of the system relative to interaction with other motion tracking and/or distance measurement devices.

Although not required, some embodiments of the controller 140 may employ or be in communication with a user interface 220. The user interface 220 may be in communication with the processing circuitry 200 to receive an indication of a user input at the user interface 220 and/or to provide an audible, visual, tactile or other output to the operator 110. As such, the user interface 220 may include, for example, a display, one or more switches, lights, buttons or keys, speaker, and/or other input/output mechanisms. In an example embodiment, the user interface 220 may include the hearing protection 180 of FIG. 1, or one or a plurality of colored lights to indicate status or other relatively basic information. However, more complex interface mechanisms could be provided in some cases.

The controller 140 may employ or utilize components or circuitry that acts as a device interface 230. The device interface 230 may include one or more interface mechanisms for enabling communication with other devices (e.g., the tool position sensor 122, the tool distance sensor 132, the chain brake 170, the hearing protection 180, the IMU-based sensors 120, the distance sensors 130, the magnetic sensors 182, electronic tag sensors 184 and/or the optical sensors 190). In some cases, the device interface 230 may be any means such as a device or circuitry embodied in either hardware, or a combination of hardware and software that is configured to receive and/or transmit data from/to components in communication with the processing circuitry 200 via internal communication systems of the chainsaw 100 and/or via wireless communication equipment (e.g., a one way or two way radio). As such, the device interface 230 may include an antenna and radio equipment for conducting Bluetooth, WiFi, or other short range communication, or include wired communication links for employing the communications necessary to support the functions described herein.

In FIG. 2, the tool position sensor 122 and/or the IMU-based sensors 120 may be part of or embodied as a first sensor network 240, and the tool distance sensor 132 and/or the distance sensors 130 may be part of or embodied as a second sensor network 250. However, it should be appreciated that the first sensor network 240 and the second sensor network 250 could alternatively include any of the other sensor types noted above in alternative embodiments. Meanwhile, the tool position sensor 122 and/or the tool distance sensor 132 along with the magnetic sensors 182 and the electronic tag sensors 184 may be part of or embodied as a third sensor network 252 and a fourth sensor network 254, respectively. The optical sensors 190 may be part of or embodied as a fifth sensor network 256. However, it should be appreciated that the third sensor network 252, the fourth sensor network 254, and the fifth sensor network 256 could alternatively include any of the other sensor types noted above in alternative embodiments. Thus, the first, second, third, fourth and fifth sensor networks 240, 250, 252, 254 and 256 may be in communication with the controller 140 via the device interface 230. However, other direct or other indirect connection or communication mechanisms could be provided in some cases.

The processor 210 may be embodied in a number of different ways. For example, the processor 210 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 210 may be configured to execute instructions stored in the memory 212 or otherwise accessible to the processor 210. As such, whether configured by hardware or by a combination of hardware and software, the processor 210 may represent an entity (e.g., physically embodied in circuitry—in the form of processing circuitry 200) capable of performing operations according to embodiments of the present invention while configured accordingly. Thus, for example, when the processor 210 is embodied as an ASIC, FPGA or the like, the processor 210 may be specifically configured hardware for conducting the operations described herein. Alternatively, as another example, when the processor 210 is embodied as an executor of software instructions, the instructions may specifically configure the processor 210 to perform the operations described herein.

In an example embodiment, the processor 210 (or the processing circuitry 200) may be embodied as, include or otherwise control the operation of the controller 140 based on inputs received by the processing circuitry 200. As such, in some embodiments, the processor 210 (or the processing circuitry 200) may be said to cause each of the operations described in connection with a self-calibration module 260, a self-assessment module 270, a self-healing module 272, and a network monitoring module 280 relative to undertaking the corresponding functionalities associated therewith responsive to execution of instructions or algorithms configuring the processor 210 (or processing circuitry 200) accordingly. In general, the processor 210 may operate to enable the controller 140 to detect a trigger event based on measurements made by any one of the multiple sensor networks and to initiate a protective action with respect to the power tool (e.g., chainsaw 100) responsive to detecting the trigger event. The controller 140 may be further configured to monitor performance data associated with each of the sensor networks to perform sensor fusion based on the performance data. The sensor fusion may generally enable backup functions, accuracy improvement, detection of malfunctioning sensors or sensor networks, sensor or sensor network shutdown, and/or the like.

In an exemplary embodiment, the memory 212 may include one or more non-transitory memory devices such as, for example, volatile and/or non-volatile memory that may be either fixed or re-movable. The memory 212 may be configured to store information, data, applications, instructions or the like for enabling the processing circuitry 200 to carry out various functions in accordance with exemplary embodiments of the present invention. For example, the memory 212 could be configured to buffer input data for processing by the processor 210. Additionally or alternatively, the memory 212 could be configured to store instructions for execution by the processor 210. As yet another alternative or additional capability, the memory 212 may include one or more databases that may store a variety of data sets. Among the contents of the memory 212, applications may be stored for execution by the processor 210 in order to carry out the functionality associated with each respective application. In some cases, the applications may include instructions for motion tracking and distance measurement as described herein, along with calibration, assessment for failover control, and backup operation functions.

In an example embodiment, the network monitoring module 280 may be operably coupled to each of the first, second, third, fourth and fifth sensor networks 240, 250, 252, 254 and 256 to receive information on respective measurements made thereby, or to monitor individual sensors (e.g., for operability or accuracy). In some embodiments, the network monitoring module 280 may receive information in real time, or near real time, and record the information received in association with each respective one of the sensor networks. The information received and stored may, in some cases, be performance data that is directly or indirectly indicative of the power levels, noise levels, or stability of signals received. Thus, for example, signal to noise ratios, or other indications of interference, weak signals, etc., may be recorded and available for use and/or analysis by other modules (e.g., the self-calibration module 260, the self-assessment module 270, and/or the self-healing module 272).

Although not required, in some embodiments, the network monitoring module 280 (or some other location such as memory 212) may also store a table or listing of values that are in a normal range for any of the performance data, or threshold values that define minimum performance criteria or acceptable levels for performance data. Thus, for example, not only may the network monitoring module 280 record the performance data, but the network monitoring module 280 may also record a table of acceptable ranges of values for the performance data. However, such table (or tables) may alternatively be stored by individual ones of the self-calibration module 260, the self-assessment module 270, and/or the self-healing module 272.

Regardless of where stored, the table or listing of values may be useful for comparing values measured where such values are related to common parameters (e.g., measurements relating to a same distance). The accuracy of the common parameter may be more readily determined particularly when the common parameter is a fixed distance that is known accurately. In some embodiments, multiple ones of the sensor networks may include or be capable of measuring at least one common parameter. Thus, for example, at least some sensors from different sensor networks may be collocated (or at least located in similar locations to attempt to measure the common parameter). The existence of at least one common parameter may allow a comparison of the measured values for the common parameter between two different sensor networks, and two different sensors. The common parameter may, when calibrated in each system have either a known difference, or be set or arranged to be identical (or nearly so). Differences in the common parameter may then be used to determine (e.g., based on known geometrical relationships associated with other sensors positions) correction factors to be used to calibrate or adjust measurements, or to enhance accuracy of other sensor networks. In some cases, at least one single common parameter may be prescribed for all of the (or multiples ones of the) first, second, third, fourth and fifth sensor networks 240, 250, 252, 254 and 256. However, in other cases, no single common parameter may exist for all networks, but pairs of networks may share common parameters, and corrections or adjustments may be chained between the different networks when differences start to be noticeable.

In some cases, it may be possible to note that a single sensor of a sensor network is apparently providing faulty readings. This may be possible when all other sensors (or measurements associated with such sensors) appear to be functioning normally, but only a single sensor (or the measurements associated with the single sensor) appear to be malfunctioning. This can be determined by comparing current data to historical data for the same network, and/or by comparing values across multiple sensor networks, where only some measurements in one network (i.e., those associated with a single sensor) appear to be flawed. When a single sensor appears to be faulty, the specific sensor may be identified and the single sensor may be repaired, cleaned, or otherwise addressed to improve functioning. For example, an optical sensor may be dusty, or another sensor may have moved or shifted location from its normal location.

Calibration functions may be performed by the self-calibration module 260. In this example, the calibration may be applicable to any one or more of the first, second, third, fourth and fifth sensor networks 240, 250, 252, 254 and 256. Thus, as few as one of the first, second, third, fourth and fifth sensor networks 240, 250, 252, 254 and 256 or as many as all of the first, second, third, fourth and fifth sensor networks 240, 250, 252, 254 and 256 may be calibrated using the self-calibration module 260. Any combination of any number of the sensor networks may therefore be calibrated.

The calibration functions performed by the self-calibration module 260 may, in some cases, be performed based on information provided to the self-calibration module 260 by the network monitoring module 280 either proactively or responsively. In this regard, for example, the self-calibration module 260 may compare performance data for one of the sensor networks to the values defining ranges or thresholds of acceptable values. If the performance data received from one (or more) of the sensor networks (e.g., the first sensor network 240) is not within acceptable ranges to above the threshold, the self-calibration module 260 may enter a calibration routine for the corresponding sensor network (e.g., the first sensor network 240 in this example). The calibration routine may, for example, seek to use performance data from one (or more) of the other sensor networks (e.g., the second, third, fourth or fifth sensor networks 250, 252, 254 and 256) to attempt to calibrate the sensors of the first sensor network 240.

As an alternative, the readings or values for various distance measurements that may be made commonly between any of the first, second, third, fourth or fifth sensor networks 240, 250, 252, 254 and 256 (e.g., with respect to a common parameter) may be recorded for comparison to each other (either at the network monitoring module 280 or the self-calibration module 260). If the comparison shows one of the measured distances being an outlier from the others by a threshold amount, the corresponding outlier measurement may be indicative of a need to calibrate the sensors of the corresponding network. Thus, for example, the network with the outlier measurement may be identified for performing the calibration routine as described above. In this regard, for example, the calibration process may include resetting velocity and displacement errors that are introduced, and may build up over time, from the IMU-based sensors 120 and/or other sensors of the various sensor networks.

In some embodiments, the self-calibration module 260 may be configured to apply a correction factor to an outlier reading in order to correct the outlier reading from being an outlier to being back within acceptable limits. The self-calibration module 260 may also evaluate the correction factor applied over time to determine if the correction factor is working to provide an appropriate correction or, if the correction factor does not consistently correct the value appropriately such as when the correction factor does not cure the inaccuracy when other movements, positions, or activities are undertaken, then the self-calibration module 260 may instead either take the corresponding sensors (generating the outlier reading) out of operation or recommend the same by providing a notification to the operator 110. The notification may indicate, for example, that the IMU-based sensors 120 (either generally or a specific one or two of them) need maintenance or repair, and are not useable until repaired and calibrated.

In an example embodiment, the self-calibration module 260 may be used to define (or learn) one or more specific tool and/or body positions (or combinations thereof) that correlate to calibration positions. In this regard, for example, certain positions may have known sensor data associated therewith. Accordingly, the chainsaw 100 may be detected as being held in one or more of such positions during a calibration procedure in order to reset to a known state of parts of the sensor data. Given that there may be multiple positions, various different parts of the sensor data may be reset until a full reset is achieved by going through a full sequence of calibration positions.

Accordingly, the user manual or a maintenance manual for the chainsaw 100 may list the calibration positions. A calibration mode may be entered, and the corresponding positions may be sequentially cycled through. The calibrated positions may relate to both the chainsaw 100 and the operator 110 in some cases. Thus, for example, the operator 110 (who may be a maintenance technician, or the owner in various cases) may be guided as to the poses to assume with the chainsaw 100 while wearing the IMU-based sensors 120, and/or any of the other sensors of the second, third and fourth sensor networks 250, 252 and 254. The positions may also or alternatively be sensed by tactile sensors that may be disposed at the chainsaw 100. Thus, for example, the sensors may detect that the operator 110 has maneuvered the chainsaw 100 to one of the calibration positions based on how the operator 110 is holding the chainsaw 100, and/or based on the pressing of the trigger and correlated accelerometer and/or magnetometer readings in order to determine vertical or horizontal orientation of the chainsaw 100. In some cases, the inclusion of multiple ones of the IMU-based sensors 120 and/or any of the other sensors of the second, third and fourth sensor networks 250, 252 and 254, and sensors on the chainsaw 100 may ensure sufficient independence to achieve good results. Thus, given that the chainsaw 100 may be detected to be in various positions, the calibration can automatically occur when one of the calibrated positions is detected (i.e., not responsive to a guided pose, but during use and responsive to detecting that a pose has been assumed with the chainsaw 100). Detection of position (and specifically of calibration positions) may occur when the operator 110 pulls the trigger (or actuates another button or operative member of the chainsaw 100). In some cases, the tactile pressure sensor in the handles of the chainsaw 100 (as determined by sensors) may be used to determine a position of the hands relative to determining a current pose of the operator 110 and/or position of the chainsaw 100.

In some cases, the calibration procedure may be a part of routine maintenance with a prescribed periodicity. However, the calibration procedure can also or alternatively occur automatically when a calibrated position is detected (either every time, or if calibration in the corresponding calibrated position has not been performed within a given threshold period of time). The calibration algorithm may be configured to perform a double integration of acceleration for linear displacement, gyro data for direction, and Kalman filtering for improved prediction of motion tracking by error correction. Moreover, as noted above, the calibration may be initiated responsive to comparisons of various network sensor readings to each other to identify outlier readings.

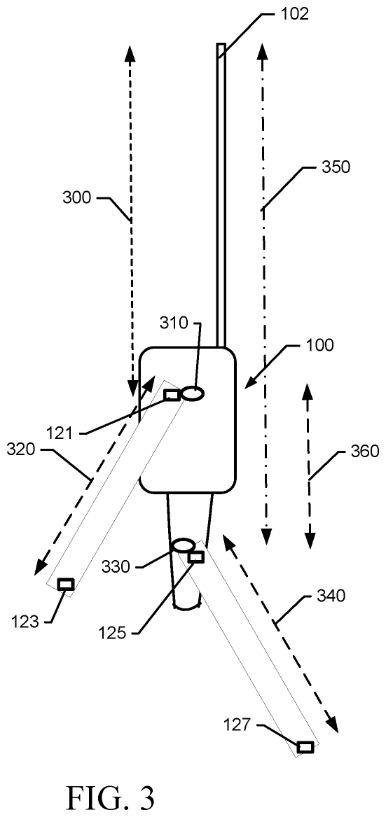

FIG. 3 illustrates a schematic view of a calibration position of an example embodiment. As shown in FIG. 3, the chainsaw 100 may be detected as being held in a particular pose by an operator with the IMU-based sensors 120 at known locations (based on the particular pose). In some cases, the IMU-based sensors 120 may be affixed at (e.g., mounted within) fixed or known locations on PPE such as a jacket or legwear. In this example, the IMU-based sensors 120 include a left glove sensor 121 and a left elbow sensor 123, a right glove sensor 125 and a right elbow sensor 127. However, it should be appreciated that other sensors at other locations could also be included. Thus, the locations and specific sensors shown are merely provided to facilitate explanation of an example embodiment, and are not intended to limit example embodiments.

As can be appreciated from FIG. 3, a distance 300 from the end of the bar of the chainsaw 100 to the left glove sensor 121, which would be known to be on the front handle of the chainsaw 100 may be known. As mentioned above, one or more tactile sensors 310 may be disposed on the front handle to confirm the specific location of the left hand of the operator (and/or the left glove sensor 121). The distance 320 from the left glove sensor 121 to the left elbow sensor 123 may also be known, particularly for the designated pose. Similarly, one or more tactile sensors 330 may be disposed at the rear handle of the chainsaw 100. The tactile sensors 330 may confirm the specific location of the right hand of the operator (and/or the right glove sensor 125). Meanwhile, the distance 340 from the right glove sensor 125 to the right elbow sensor 127 may also be known, particularly for the designated pose. A distance 350 from the end of the bar of the chainsaw 100 to the right glove sensor 125, and a distance 360 between the tactile sensors 310 and 330, may also be known. Accordingly, with the known distances (300, 320, 340, 350 and 360), and stored baseline data associated with the pose, the IMU-based sensors 120 or other network sensors can be calibrated.

The self-assessment module 270 may be configured to determine relative performance rankings or evaluations of any or all of the first, second, third, fourth or fifth sensor networks 240, 250, 252, 254 and 256. Thus, for example, the self-assessment module 270 may be used, similar or the same as noted above for the self-calibration module 260, when one of the sensor networks is generating outlier readings, or is otherwise generating inaccurate results. As noted above, the evaluation of network performance may be based on direct measurement of network components, or based on comparisons of commonly measurable performance data (or other parameters) between the networks (to identify outlier readings). However, unlike the self-calibration module 260, which generally aims to calibrate sensors to improve measurement accuracy, the self-assessment module 270 may instead simply rank or prioritize readings or measurements based on corresponding perceptions of the accuracy of the sensor network generating such readings or measurements.

Accordingly, for example, one of the sensor networks may be established as a primary network for the provision of all or a selected set of measurable parameters, and another one of the sensor networks may be established as a backup to the primary network. In other cases, a full ranking (e.g., from first to fifth, if all five sensor networks are employed) may be provided for each of the sensor networks. The ranking may be comprehensive (e.g., for all measurable parameters), or may be made for individual measurable parameters. The rankings may be made and adjusted as performance data is measured and analyzed. Thus, for example, the self-assessment module 270 may continuously monitor the performance of the sensor networks to ensure that the best data is being used at any given time.

The self-assessment module 270 may also use sensor fusion to improve the accuracy of one or more of the sensor networks. Thus, for example, the self-assessment module 270 may be configured to apply a correction factor to sensor measurements generated by one of the sensor networks based on inputs provided from other ones of the sensor networks to enhance accuracy. The correction factor may be determined based on differences between commonly measured parameters between respective different sensor networks. Thus, for example, if the first, second and third sensor networks 240, 250 and 252 each measure a common parameter, and the first and second networks 240 and 250 achieve measurement values that are very close to each other, whereas the third network 252 achieves a measurement value for the common parameter that is off by an offset value, the offset value may be selected as the correction factor. The correction factor may then be applied to other measurements made by the third network 252, or may be modified to account for geometrical differences or orientation differences, when appropriate. Particularly in situations where there are more than one common parameters between sensor networks, it can be determined if the correction factor actually increases accuracy due to being consistently applicable to improve measurement value accuracy, or instead distinguish that a sensor appears to be misplaced, non-operational, or inaccurate for other reasons.

The self-healing module 272 may also use sensor fusion to improve the accuracy of one or more of the sensor networks and/or respond to faults or malfunctions that occur in the system. Thus, for example, the self-healing module 272 may be configured to define fail-over protocols to replace sensors or sensor networks whenever a malfunction occurs. For a sensor network that appears to be malfunctioning, or performing poorly, the self-healing module 272 may shut down the corresponding sensors of the sensor network, or otherwise provide an indication that measurements made by the malfunctioning sensor or sensor network should be ignored. The self-healing module 272 may therefore operate when accuracy improvement is not possible by correction, but instead only by replacement or isolation of the faulty network. The self-healing module 272 may utilize the ranking discussed above to determine which sensor network to fail-over to, when another sensor network is faulty.

Thus, the system will never be without a functioning sensor network, and the best performing functioning sensor network at that, to rely upon for detection of the trigger event, and for initiating protective actions when the trigger event is detected. However, in some embodiments, whenever a faulty sensor or network is detected, the detection of the fault may, instead of causing a fail-over to another sensor or sensor network or a notification of the fault, cause a shutdown of the chainsaw 100 (or other power tool). In some cases, the shutdown may accompany a notification of the fault either in general terms, or specifically identifying the sensor or sensor network that is the source of the fault.

In some embodiments, the controller 140 may also include or be operably coupled to a machine learning module, that may employ trained models to identify faults, correct for such faults, perform calibration, identify when calibration is needed, and/or the like. The machine learning module may be trained in the lab prior to deployment of the chainsaw 100, or may operate actively while the chainsaw 100 operates in order to learn actively during operation.

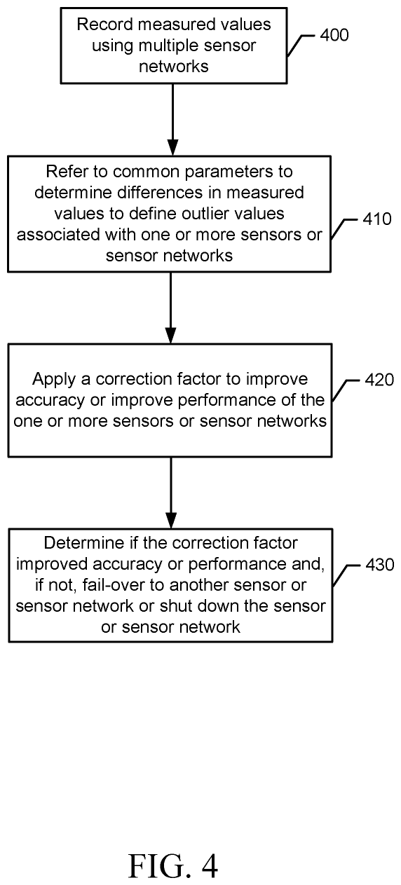

FIG. 4 is a block diagram of an example of sensor fusion that may be performed by the controller 140 in accordance with an example embodiment. As shown in FIG. 4, measured values may be obtained and recorded using multiple sensor networks (e.g., the first, second, third, fourth and fifth sensor networks 240, 250, 252, 254 and 256) at operation 400. At operation 410, the controller 140 may refer to common parameters to determine differences in measured values to define outlier values associated with one or more sensors or sensor networks. Thereafter, at operation 420, the controller 140 may apply a correction factor to improve accuracy or improve performance of the one or more sensors or sensor networks. At operation 430, the controller 140 may determine if the correction factor improved accuracy or performance and, if not, fail-over to another sensor or sensor network or shut down the sensor or sensor network.

In some cases, variables associated with measured values may be defined in various terms such as X/Y/Z, roll/pitch/yaw, Euler, Quaternions, etc., depending on the specific implementation. Other variables may include device state, and/or a global data-structure variable including acceleration, velocity, angular velocity, position, gyro readings, etc., that can be used for sensor fusion (e.g., by the sensor fusion module 270). Based on the distances mentioned above, various local variables such as the calculated displacement (CalcDis), calculated orientation (CalcOri), and calculated velocity (CalcVel) may be measured or determined. For an example calculation for calibrated motion tracking, the following calculations could serve as one example program, which could be employed.
State: =Init ( ) //Initiation, measured position matrix based on known hand positions on handles combined with accelerometer and magnetometer readings for orientation, reinforced with machine learning (ML)-based training set data, and for init state in advised position//

Loop While (On)
Calculate( )
Function Calculate( ) (
MeasUpdate(State) //Similar to Init but measurement that is context adapted, i.e., bias parameters
continuously updated in each step//
//Calculations below use updated parameters from the MeasUpdate step//
CalcVel := ∫(Acceleration) //Calculated Velocity//
CalcDis := Initial displacement + ∫(CalcVel) //Calculated displacement//
CalcOri := Initial orientation + ∫(Angular velocity) //Calculated orientation//
Est := Update(CalcDis, CalcOri) //Continuously calculated State//
)
Function MeasUpdate ( ) (
Complex function that implements update bias parameters for state, action and observation data
(e.g., Kalman filter theory)
)

The sensor fusion performed by the controller 140 may therefore fuse data received by the motion tracking devices (e.g., the IMU-based sensors 120 and the tool position sensor 122) and by the distance measurement devices (e.g., the distance sensors 130 and the tool distance sensor 132). The data received from the motion tracking devices may be received at the controller 140 and processed to determine motion tracking information. The motion tracking information may then be provided to the controller 140 for sensor fusion.

The data received from the distance measurement devices may also be received at the controller 140 (either the same or a different instance of the controller 140) and processed to determine distance measurement information. The distance measurement information may then also be used to determine when a trigger event has occurred. Thus, for example, the controller 140 may be configured to process the distance measurement information and/or the motion tracking information from the sensor networks to determine when a trigger even has occurred. Thus, the controller 140 may define a hierarchy of priority for the distance measurement information and motion tracking information generated by the sensor networks based on a continuous evaluation of the performance data associated with each respective one of the networks. The best performing network or networks may therefore always be looked to for providing information that will be used to evaluate whether a trigger event has occurred. The trigger event may, however, have different definitions in relation to different sensor networks and situations.

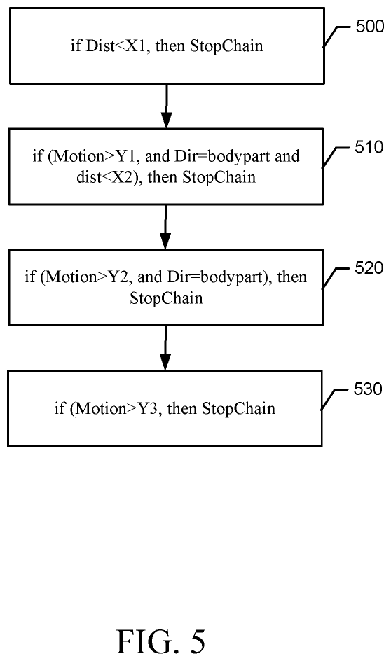

FIG. 5 is a block diagram showing an example of various trigger events that may be detected in accordance with an example embodiment. Within the context of FIG. 5, the following term definitions apply:
Dist: Distance between chain 102 and a body part;
Motion: Motion of the chainsaw bar (e.g., aggregated based on accelerometer and gyro input); and
Dir: Direction of motion of the chainsaw bar based on a calculated state.
Within this context, a first trigger event 500 may be defined for the minimum distance allowed for a stationary bar. According to the first trigger event 500, if Dist<X1, then StopChain. In other words, if the bar is closer than a minimum distance (X1), then the chain 102 should be stopped. A second trigger event 510 may be defined for the minimal distance allowed during high velocity motion. According to the second trigger event 510, if (Motion>Y1, and Dir=bodypart and dist<X2), then StopChain. In other words, if the bar is in motion above a certain velocity (Y1) and the distance to a body part is less than a minimal distance (X2) when motion toward any sensor is detected, then the chain 102 should be stopped. A third trigger event 520 may be defined for the maximum allowed motion velocity regardless of distance. According to the third trigger event 520, if (Motion>Y2, and Dir=bodypart), then StopChain. In other words, if the bar is in motion above a certain velocity (Y2) when motion toward any body part is detected, then the chain 102 should be stopped no matter what the current distance happens to be. A fourth trigger event 530 may be defined for the maximum allowed motion velocity regardless of direction. According to the fourth trigger event 530, if (Motion>Y3), then StopChain. In other words, if the bar is in motion above a certain velocity (Y3), then the chain 102 should be stopped no matter what the current distance happens to be, and no matter what the direction of movement of the bar is. This is just one example of a set of trigger events that can be employed.

Accordingly, in one example embodiment, a system for protecting an operator of a power tool may be provided. The system may include a first sensor network, a second sensor network, a third sensor network, and a controller configured to detect a trigger event based on measurements made by the first, second and third sensor networks and initiate a protective action with respect to the power tool responsive to detecting the trigger event. The controller may be further configured to monitor performance data associated with each of the first, second and third sensor networks to perform sensor fusion based on the performance data.

In some cases, modifications or amplifications may further be employed as optional alterations or augmentations to the description above. These alterations or augmentations may be performed exclusive of one another or in any combination with each other. In some cases, such modifications or amplifications may include (1), performing sensor fusion may include the controller being configured to monitor the performance data and select a first one of the first, second and third sensor networks as a primary network for detection of the trigger event based on the performance data, and select a second one of the first, second and third sensor networks as a backup network. In an example embodiment (2), the controller may monitor the performance data to reassign the primary network and backup network based on direct measurements of the performance data associated with the first and second sensor networks. In some cases (3), the controller may monitor the performance data to reassign the primary network and backup network based on a comparison of the performance data associated with the first and second sensor networks. In an example embodiment (4), performing sensor fusion may include the controller being configured to monitor the performance data and detect an outlier measurement associated with one of the first, second and third sensor networks, and the controller may be configured to calibrate the one of the first, second and third sensor networks based on measurements made by others of the first, second and third sensor networks. In some cases (5), performing sensor fusion may include the controller being configured to determine, based on the performance data, a correction factor to apply to measurements of one of the first, second and third sensor networks. In an example embodiment (6), the first, second and third sensor networks each measure a common parameter, and the controller may be configured to determine the correction factor based on a difference in the common parameter measured at one of the first, second and third sensor networks. In some cases (7), the first sensor network and the second sensor network may each measure a first common parameter, the second sensor network and the third sensor network may each measure a second common parameter that is different than the first common parameter, and the controller may be configured to determine the correction factor to the first sensor network based on a difference between the first common parameter and the second common parameter. In an example embodiment (8), performing sensor fusion may include the controller being configured to improve accuracy of one of the first, second and third sensor networks based on measurements made by others of the first, second and third sensor networks. In some cases (9), respective ones of the first, second and third sensor networks may include sensors of a different type relative to each other selected from a group including distance sensors that measure a time-of-flight of a carrier wave between the distance sensors, IMU-based sensors that track movement in three dimensions, optical sensors that define a field of view around a working assembly of the power tool, magnetic sensors that detect changes in a magnetic field associated with the power tool, and electronic sensors that determine distance between the electronic sensors based on power level measurements or trilateration. In an example embodiment (10), the first, second and third sensor networks may include UWB sensors distributed on clothing worn by the operator forming the first and second sensor networks and at least three UWB sensors disposed on the power tool forming the third sensor network. In some cases (11), the power tool may be a chainsaw or other power equipment with a working assembly comprising a blade or chain. In an example embodiment, some, any or all of modifications/amplifications (1) to (11) may be employed in any combination with each other.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A system for protecting an operator (110) of a power tool (100), the system comprising:
a first sensor network (240);
a second sensor network (250);
a third sensor network (252); and
a controller (140) configured to detect a trigger event based on measurements made by the first, second and third sensor networks (240, 250 and 252) and initiate a protective action with respect to the power tool (100) responsive to detecting the trigger event,
wherein the controller (140) is further configured to monitor performance data associated with each of the first, second and third sensor networks (240, 250 and 252) to perform sensor fusion based on the performance data.

2. The system of claim 1, wherein performing sensor fusion comprises the controller (140) being configured to monitor the performance data and select a first one of the first, second and third sensor networks (240, 250 and 252) as a primary network for detection of the trigger event based on the performance data, and select a second one of the first, second and third sensor networks (240, 250 and 252) as a backup network.

3. The system of claim 2, wherein the controller (140) monitors the performance data to reassign the primary network and backup network based on direct measurements of the performance data associated with the first and second sensor networks (240 and 250).

4. The system of claim 2, wherein the controller (140) monitors the performance data to reassign the primary network and backup network based on a comparison of the performance data associated with the first and second sensor networks (240 and 250).

5. The system of claim 1, wherein performing sensor fusion comprises the controller (140) being configured to monitor the performance data and detect an outlier measurement associated with one of the first, second and third sensor networks (240, 250 and 252), and
wherein the controller (140) is configured to calibrate the one of the first, second and third sensor networks (240, 250 and 252) based on measurements made by others of the first, second and third sensor networks (240, 250 and 252).

6. The system of claim 1, wherein performing sensor fusion comprises the controller (140) being configured to determine, based on the performance data, a correction factor to apply to measurements of one of the first, second and third sensor networks (240, 250 and 252).

7. The system of claim 6, wherein the first, second and third sensor networks (240, 250 and 252) each measure a common parameter, and
wherein the controller (140) is configured to determine the correction factor based on a difference in the common parameter measured at one of the first, second and third sensor networks (240, 250 and 252).

8. The system of claim 6, wherein the first sensor network (240) and the second sensor network (250) each measure a first common parameter,
wherein the second sensor network (250) and the third sensor network (252) each measure a second common parameter that is different than the first common parameter, and
wherein the controller (140) is configured to determine the correction factor to the first sensor network (250) based on a difference between the first common parameter and the second common parameter.

9. The system of claim 1, wherein performing sensor fusion comprises the controller (140) being configured to improve accuracy of one of the first, second and third sensor networks (240, 250 and 252) based on measurements made by others of the first, second and third sensor networks (240, 250 and 252).

10. The system of claim 1, wherein respective ones of the first, second and third sensor networks (240, 250 and 252) include sensors of a different type relative to each other selected from a group comprising:
distance sensors that measure a time-of-flight of a carrier wave between the distance sensors;
inertial measurement unit (IMU)-based sensors that track movement in three dimensions;
optical sensors that define a field of view around a working assembly of the power tool (100);
magnetic sensors that detect changes in a magnetic field associated with the power tool (100); and
electronic sensors that determine distance between the electronic sensors based on power level measurements or trilateration.

11. The system of claim 1, wherein the first, second and third sensor networks comprise ultra-wideband (UWB) sensors distributed on clothing worn by the operator forming the first and second sensor networks and at least three UWB sensors disposed on the power tool (100) forming the third sensor network.

12. The system of claim 1, wherein the power tool (100) is a chainsaw or other power equipment with a working assembly comprising a blade or chain (102).

13. A controller (140) comprising processing circuitry (200) for protecting an operator (110) of a power tool, the processing circuitry (200) being operably coupled to a first sensor network (240), a second sensor network (250), and a third sensor network (252), the controller (140) being configured to detect a trigger event based on measurements made by the first, second and third sensor networks (240, 250 and 252) and initiate a protective action with respect to the power tool (100) responsive to detecting the trigger event,
wherein the controller (140) is further configured to monitor performance data associated with each of the first, second and third sensor networks (240, 250 and 252) to perform sensor fusion based on the performance data.

14. The controller (140) of claim 13, wherein performing sensor fusion comprises the controller (140) being configured to monitor the performance data and select a first one of the first, second and third sensor networks (240, 250 and 252) as a primary network for detection of the trigger event based on the performance data, and select a second one of the first, second and third sensor networks (240, 250 and 252) as a backup network.

15. The controller (140) of claim 14, wherein the controller (140) monitors the performance data to reassign the primary network and backup network based on direct measurements of the performance data associated with the first and second sensor networks (240 and 250) or based on a comparison of the performance data associated with the first and second sensor networks (240 and 250).

16. The controller (140) of claim 13, wherein performing sensor fusion comprises the controller (140) being configured to monitor the performance data and detect an outlier measurement associated with one of the first, second and third sensor networks (240, 250 and 252), and
wherein the controller (140) is configured to calibrate the one of the first, second and third sensor networks (240, 250 and 252) based on measurements made by others of the first, second and third sensor networks (240, 250 and 252).

17. The controller (140) of claim 13, wherein performing sensor fusion comprises the controller (140) being configured to determine, based on the performance data, a correction factor to apply to measurements of one of the first, second and third sensor networks (240, 250 and 252).

18. The controller (140) of claim 17, wherein the first, second and third sensor networks (240, 250 and 252) each measure a common parameter, and
wherein the controller (140) is configured to determine the correction factor based on a difference in the common parameter measured at one of the first, second and third sensor networks (240, 250 and 252).

19. The controller (140) of claim 17, wherein the first sensor network (240) and the second sensor network (250) each measure a first common parameter,
wherein the second sensor network (250) and the third sensor network (252) each measure a second common parameter that is different than the first common parameter, and
wherein the controller (140) is configured to determine the correction factor to the first sensor network (250) based on a difference between the first common parameter and the second common parameter.

20. The controller (140) of claim 13, wherein performing sensor fusion comprises the controller (140) being configured to improve accuracy of one of the first, second and third sensor networks (240, 250 and 252) based on measurements made by others of the first, second and third sensor networks (240, 250 and 252).

21. The controller (140) of claim 13, wherein respective ones of the first, second and third sensor networks (240, 250 and 252) include sensors of a different type relative to each other selected from a group comprising:
distance sensors that measure a time-of-flight of a carrier wave between the distance sensors;
inertial measurement unit (IMU)-based sensors that track movement in three dimensions;
optical sensors that define a field of view around a working assembly of the power tool (100);
magnetic sensors that detect changes in a magnetic field associated with the power tool (100); and
electronic sensors that determine distance between the electronic sensors based on power level measurements or trilateration.

22. A system for protecting an operator (110) of a power tool (100), the system comprising:
a first sensor network (240);
a second sensor network (250); and
a controller (140) configured to detect a trigger event based on measurements made by the first and second sensor networks (240 and 250) and initiate a protective action with respect to the power tool (100) responsive to detecting the trigger event,
wherein the controller (140) is further configured to monitor performance data associated with each of the first and second sensor networks (240 and 250) to perform sensor fusion based on the performance data.

23. The system of claim 22, wherein performing sensor fusion comprises the controller (140) being configured to monitor the performance data and select a first one of the first and second sensor networks (240 and 250) as a primary network for detection of the trigger event based on the performance data, and select a second one of the first and second sensor networks (240 and 250) as a backup network.

24. The system of claim 23, wherein the controller (140) monitors the performance data to reassign the primary network and backup network based on direct measurements of the performance data associated with the first and second sensor networks (240 and 250).

25. The system of claim 23, wherein the controller (140) monitors the performance data to reassign the primary network and backup network based on a comparison of the performance data associated with the first and second sensor networks (240 and 250).

26. The system of claim 22, wherein performing sensor fusion comprises the controller (140) being configured to monitor the performance data and detect an outlier measurement associated with one of the first and second sensor networks (240 and 250), and
wherein the controller (140) is configured to calibrate the first sensor network (240) based on measurements made by the second sensor network (250).

27. The system of claim 22, wherein performing sensor fusion comprises the controller (140) being configured to determine, based on the performance data, a correction factor to apply to measurements of one of the first and second sensor networks (240 and 250).

28. The system of claim 27, wherein the first and second sensor networks (240 and 250) each measure a common parameter, and
wherein the controller (140) is configured to determine the correction factor based on a difference in the common parameter measured at one of the first and second sensor networks (240 and 250).

29. The system of claim 22, wherein performing sensor fusion comprises the controller (140) being configured to improve accuracy of the first sensor network (240) based on measurements made by the second sensor network (250).

30. The system of claim 22, wherein respective ones of the first and second sensor networks (240 and 250) include sensors of a different type relative to each other selected from a group comprising:
distance sensors that measure a time-of-flight of a carrier wave between the distance sensors;
inertial measurement unit (IMU)-based sensors that track movement in three dimensions;
optical sensors that define a field of view around a working assembly of the power tool (100);
magnetic sensors that detect changes in a magnetic field associated with the power tool (100); and
electronic sensors that determine distance between the electronic sensors based on power level measurements or trilateration.
